(19) United States
(12) Patent Application Publication
(10) Pub. No.: US 2018/0299969 A1
(43) Pub. Date: Oct. 18, 2018

(54) ELECTRONIC SIGNAL TRANSMISSION AND CONTROL SYSTEM

(71) Applicant: Chin-Hui LIANG, New Taipei (TW)

(72) Inventor: Chin-Hui LIANG, New Taipei (TW)

(21) Appl. No.: 15/711,519

(22) Filed: Sep. 21, 2017

(30) Foreign Application Priority Data
Apr. 13, 2017 (TW) 106205162

(51) Int. Cl. G06F 3/023; G06F 3/14; G06F 13/12; G06F 13/38

(52) U.S. Cl. CPC G06F 3/023; G06F 13/387; G06F 13/12; G06F 3/14

(57) ABSTRACT

An electronic signal transmission and control system includes multiple electronic equipment hosts each including an interface control unit and an address converter unit connected to the interface control unit for converting the signal address transmitted by the associating electronic equipment host, and a management and control equipment including a signal control device for receiving the electronic signal addresses being transmitted at different times by the respective electronic equipment hosts, a processing unit connected to the signal control device for retrieving and reading the contents of the electronic signal address provided by each electronic equipment host and broadcasting the processed electronic signal address through the signal control device to the respective electronic equipment host.

This application claims the priority benefit of Taiwan patent application number 106205162, filed on Apr. 13, 2017.

### BACKGROUND OF THE INVENTION

### 1. Field of the Invention

The present invention relates to electric technology and more particularly, to an electronic signal transmission and control system, which uses one management and control equipment to synchronously transmit respective electronic signal addresses to multiple electronic equipment hosts and to synchronously control the operation of the multiple electronic equipment hosts, facilitating rapid operation of the electronic equipment hosts.

### 2. Description of the Related Art

With the continuous progress and innovation of electronic technology, information and communication technologies have also been rapidly developed, increasing the rate of computer use. The use of a computer to perform word processing or information processing operations can save you a lot of inconvenience. Computer users usually use a keyboard, a mouse and/or other peripheral input device to control the computer. But in response to different needs in work or management, a number of computers may be used for a variety of operations. For example, small and medium enterprises or companies usually have a number of computers for handling different jobs or different transactions, or large system operators or communications manufacturers may have hundreds or thousands of computer hosts, servers, etc. If each computer host or server is operated and controlled through a respective keyboard or mouse, the expense will be huge, and the many keyboards and/or mice also occupy a large space, complicating the operation. Through a KVM (Keyboard-Video-Mouse) switch, a computer operating system can manage and control multiple computer hosts and their peripherals, etc., saving the mouse, keyboard and other peripheral equipment costs, facilitating the management of a large number of computers, and allowing rapid detection of the operations of multiple computers.

The use of a KVM (keyboard-Video-Mouse) switch allows a central computer system to manage and control multiple computer hosts, server computers and related peripheral devices (such as touch screen, security device, smart card reader, barcode reader) The computer hosts or server computers transmit electronic signals at different times to the central computer system, and then the central computer system processes the electronic signals and responds to the respective computer hosts or server computers successively. This processing is quite cumbersome. Because different computer hosts or server computers from different manufacturers or system operators are configured to transmit electronic signals in different modes, the operation of the central computer system in controlling the computer hosts or server computers is relatively computed.

Usually the central computer system needs to switch from one computer host or server computer to another one by one for receiving the respective messages, and then to handle the messages one by one, and then to give a respective response to each computer host or server computer one by one, making the processing of the central computer system quite time-consuming and labor-wasting, and causing time delay in the operation of the computer hosts or server computers. The settling time is lengthened when time delay occurs. Thus, there are still many deficiencies to be improved. Therefore, how to solve the time-consuming and labor-wasting problems encountered in the use of a KVM (keyboard-Video-Mouse) switch in a central computer system in managing and controlling multiple computer hosts or server computers using the conventional techniques is the subject the relevant manufacturers need to study.

### SUMMARY OF THE INVENTION

The present invention has been accomplished under the circumstances in view. It is therefore the main object of the present invention to provide an electronic signal transmission and control system, which uses one management and control equipment to synchronously transmit respective electronic signal addresses to multiple electronic equipment hosts and to synchronously control the operation of the multiple electronic equipment hosts, facilitating quick operation of the electronic equipment hosts.

To achieve this and other objects of the present invention, an electronic signal transmission and control system comprises a plurality of electronic equipment hosts and a management and control equipment. The electronic equipment hosts each comprise an interface control unit, and an address converter unit connected to the interface control unit for converting the signal address transmitted by the associating electronic equipment host. The management and control equipment comprises a signal control device for receiving the electronic signal addresses being transmitted at different times by the respective electronic equipment hosts, and a processing unit connected to the signal control device for retrieving and reading the contents of the electronic signal address provided by each electronic equipment host and transmitting the processed electronic signal address through the signal control device to the respective electronic equipment host.

Further, the electronic equipment hosts can be desktop computers, notebook computers, industrial computers or server computers. The interface control unit of each electronic equipment host is universal serial bus (USB).

Further, the address converter units of the electronic equipment hosts and the signal control device of the management and control equipment are configured to calculate the contents of the electronic signal addresses through a matrix equation. The matrix equation is:

$$A = {X 1 , X 2 , X 3 , X 4 , X 5 , … , Xn}_{}^{} and B = ( \begin{matrix}Y 1 \\ Y 2 \\ Y 3 \\ Y 4 \\ Y 5 \\ ⋮ \\ Yn\end{matrix} ) , and$$

$$C = A \times B = ( X 1 \times Y 1 ) + ( X 2 \times Y 2 ) + ( X 3 \times Y 3 ) … ( XN \times YN ) .$$

Each coefficient of equation A contains at least two electronic signal addresses transmitted by at least two said electronic equipment hosts; each coefficient of equation B is the address signal processed for response by the management and control equipment according to the electronic signal address of one respective electronic equipment host, for example, the electronic signal address of the address converter unit of the respective electronic equipment host, for example, the address transmitted by the respective address converter unit:

$$A = {0 , 0 , 1 , 0 , 0 , … , 0}_{}^{} , \qquad Equation A$$

equation B of the signal control device:

$$B = ( \begin{matrix}3 \\ 2 \\ 6 \\ 0 \\ 1 \\ ⋮ \\ 5\end{matrix} ) , and C = A \times B = [ 6 ] .$$

Thus, the management and control equipment transmits the signal to the third electronic equipment host.

Further, the processing unit of the management and control equipment can be a microcontroller unit or chip. Preferably, the management and control equipment further comprises a signal acquisition unit electrically connected to the processing unit for acquiring external signal data, and a signal hub (USB Hub) electrically connected to the signal acquisition unit. Further, the signal control device of the management and control equipment can be a KVM (Keyboard-Video-Mouse) switch. Further, peripheral apparatuses, such as keyboard, video, mouse, security device, etc. are electrically connected to the signal hub (USB Hub).

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is a system block diagram of an electronic signal transmission and control system in accordance with the present invention.

FIG. 2 is a simple block diagram illustrating the electronic signal transmission mode of the electronic signal transmission and control system in accordance with the present invention.

### DETAILED DESCRIPTION OF THE PREFERRED EMBODIMENT

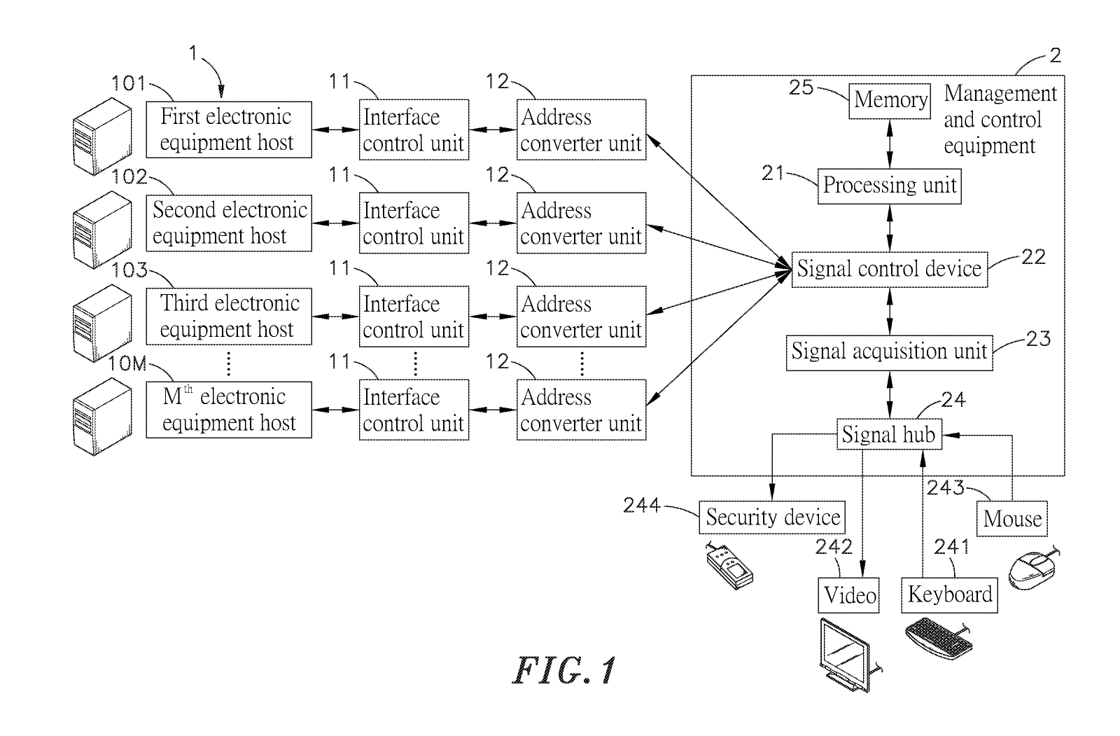

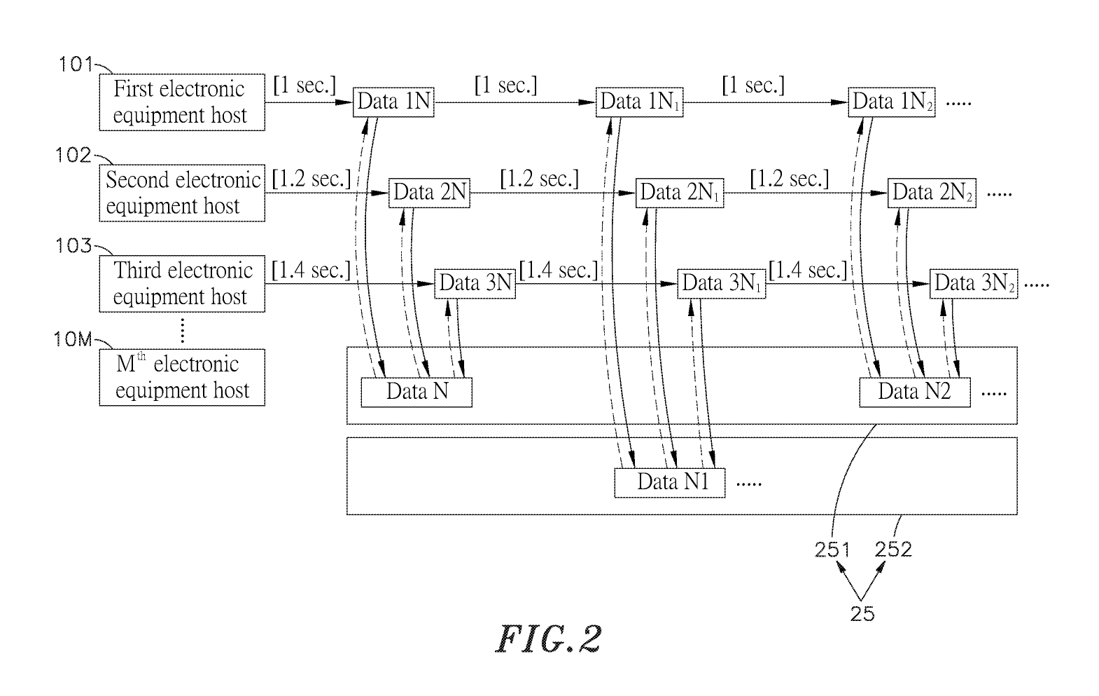

Referring to FIGS. 1 and 2, an electronic signal transmission and control system in accordance with the present invention comprises a plurality of electronic equipment hosts 1 and a management and control equipment 2.

The electronic equipment hosts 1 each comprise an interface control unit 11, and an address converter unit 12 connected to the interface control unit 11.

The management and control equipment 2 comprise a processing unit 21, a signal control device 22 and a signal acquisition unit 23 connected to the processing unit 21, and a signal hub 24 connected to the signal acquisition unit 23.

In installation, the electronic equipment hosts 1 are respectively electrically connected to the signal control device 22 of the management and control equipment 2 through the address converter units 12 thereof so that each electronic equipment host 1 can transmit a respective electronic signal address through the interface control unit 11 and the address converter unit 12 thereof to the signal control device 22 of the management and control equipment 2, which then performs an operational calculation procedure and then provides the signal to the processing unit 21 of for processing analysis, interpretation and identification. The interpreted electronic signal address is then sends back by the processing unit 21 of the management and control equipment 2 through the signal control device 22 and the address converter unit 12 to the original electronic equipment host 1, enabling the original electronic equipment host 1 to perform the operation. Thus, the multiple electronic equipment hosts 1 and the management and control equipment 2 constitute the electronic signal transmission and control system of the present invention.

Further, the electronic equipment hosts 1 can be tabletop computers, notebook computers, industrial computers or server computers. The interface control unit 11 of each electronic equipment host 1 can be any universal serial bus (USB) devices. Further, the processing unit 21 of the management and control equipment 2 can be a microcontroller unit (MCU) or chip. The signal acquisition unit 23 is connected to the processing unit 21 for acquiring external signal data through an external USB interface. The signal hub 24 (USB Hub) is connected to the signal acquisition unit 23. Further, the signal control device 22 of the management and control equipment 2 can be a KVM (Keyboard-Video-Mouse) switch.

The address converter units 12 of the electronic equipment hosts 1 and the signal control device 22 of the management and control equipment 2 are configured to calculate the contents of the electronic signal address through a matrix equation that can be:

$$A = {X 1 , X 2 , X 3 , X 4 , X 5 , … , Xn}_{}^{} and B = ( \begin{matrix}Y 1 \\ Y 2 \\ Y 3 \\ Y 4 \\ Y 5 \\ ⋮ \\ Yn\end{matrix} ) , and$$

$$C = A \times B = ( X 1 \times Y 1 ) + ( X 2 \times Y 2 ) + ( X 3 \times Y 3 ) … ( XN \times YN ) ,$$

wherein each coefficient of equation A can be at least two electronic signal addresses transmitted by at least two of the electronic equipment hosts 1; each coefficient of equation B can be the address signal processed for response by the management and control equipment 2 according to the electronic signal address of the respective electronic equipment host 1, for example, the electronic signal address of the address converter unit 12 of the respective electronic equipment host 1: equation

$$A = {0 , 0 , 1 , 0 , 0 , … , 0}_{}^{} ,$$

the electronic signal address provided by a third electronic equipment host 103, the signal control device 22 of the management and control equipment 2 is the equation

$$B = ( \begin{matrix}3 \\ 2 \\ 6 \\ 0 \\ 1 \\ ⋮ \\ 5\end{matrix} ) , thus , C = A \times B = [ 6 ] ;$$

the management and control equipment 2 stores the electronic signal address provided by each electronic equipment host 1 in a first buffer 251 or a second buffer 252 of a memory 25, and the relevant electronic signal addresses [0], [0], [6] of the first buffer 251 or the second buffer 252 are then respectively transmitted back to a first electronic equipment host 101, a second electronic equipment host 102 and the third electronic equipment host 103, allowing the third electronic equipment host 103 to carry out the related operation, such as: write, read, erase, burn or check.

For the different electronic equipment hosts 1 provided by different manufacturers, the outward transmitting electronic signal address and the transmitting time of the electronic equipment hosts 1 will be different (see also FIG. 2). For example, the time at which the first electronic equipment host 101 transmits the electronic signal address [data 1N] is the interval [1 sec.], after every [1 sec.], the data of the electronic signal address [1N, 1N₁, 1N₂, 1N₃ . . . ] is transmitted through the interface control unit 11 and the address converter unit 12 to the management and control equipment 2, thus, a keyboard 241, a mouse 243 or other input device that is electrically connected to the signal hub 24 of the management and control equipment 2 is operated to give an operation instruction through the first buffer 251 or the second buffer 252 of the memory 25 in response to the address signal data[1N, 1N₁, 1N₂, 1N₃ . . . ] provided by the first electronic equipment host 101. The time at which the second electronic equipment host 102 transmits the electronic signal address [data 2N] is the interval [1.2 sec.], after every [1.2 sec.], the data of the electronic signal address [2N, 2N₁, 2N₂, 2N₃ . . . ] is transmitted through the interface control unit 11 and the address converter unit 12 to the management and control equipment 2, thus, the keyboard 241, the mouse 243 or other input device that is electrically connected to the signal hub 24 of the management and control equipment 2 is operated to give an operation instruction through the first buffer 251 or the second buffer 252 of the memory 25 in response to the address signal data[2N, 2N₁, 2N₂, 2N₃ . . . ] provided by the second electronic equipment host 102. The time at which the third electronic equipment host 103 transmits the electronic signal address [data 3N] is the interval [1.4 sec.], after every [1.4 sec.], the data of the electronic signal address [3N, 3N₁, 3N₂, 3N₃ . . . ] is transmitted through the interface control unit 11 and the address converter unit 12 to the management and control equipment 2, thus, the keyboard 241, the mouse 243 or other input device that is electrically connected to the signal hub 24 of the management and control equipment 2 is operated to give an operation instruction through the first buffer 251 or the second buffer 252 of the memory 25 in response to the address signal data [3N, 3N₁, 3N₂, 3N₃ . . . ] provided by the third electronic equipment host 103. The time at which a M^{th} electronic equipment host 10M transmits the electronic signal address [data MN] is the interval [1.M sec.], after every [1.M sec.], the data of the electronic signal address [MN, MN₁, MN₂, MN₃ . . . ] is transmitted through the interface control unit 11 and the address converter unit 12 to the management and control equipment 2, thus, the keyboard 241, the mouse 243 or other input device that is electrically connected to the signal hub 24 of the management and control equipment 2 is operated to give an operation instruction through the first buffer 251 or the second buffer 252 of the memory 25 in response to the address signal data [MN, MN₁, MN₂, MN₃ . . . ] provided by the M^{th} electronic equipment host 10M.

Because the time at which each electronic equipment host 1 transmits the respective electronic signal address to the management and control equipment 2 is different, the management and control equipment 2 can receive the respective electronic signal addresses at different times for analysis and then provides respective operation instructions to reply to the relevant electronic signal addresses of the respective electronic equipment hosts 1 after analysis. Thus, the management and control equipment 2 can receive and replay the electronic signal addresses of the multiple electronic equipment hosts 1, achieving the object of processing the electronic signal addresses of multiple electronic equipment hosts.

Further, when the management and control equipment 2 to carry out write, read, erase, burn, check or any other operation on the electronic equipment host 1, the electronic signal address being transmitted by each electronic equipment host 1 to the management and control equipment 2 is also different. The different electronic signal addresses provided the respective electronic equipment hosts 1 {for example: the electronic signal address (write) of the first electronic equipment host 101 is [6], the electronic signal address (write) of the second electronic equipment host 102 is [3], the electronic signal address (write) of the third electronic equipment host 103 is [4], the electronic signal address (write) of the M^{th} electronic equipment host 10M is [5]}, are calculated and analyzed through the address converter unit 12 and the signal control device 22 and then transmitted to the processing unit 21. After reading, the processing unit 21 transmits the electronic signal address of “write” through the signal control device 22 to the address converter units 12 of the respective electronic equipment hosts 1. Thus, the “write” operation is synchronously carried out on the electronic equipment hosts 1. For giving an operation instruction (such as: read, erase, burn or check) according to different electronic signal addresses, even the electronic signal addresses provided by the respective electronic equipment hosts 1 are different, these electronic signal addresses address are calculated and analyzed through the respective converter units 12 and the signal control device 22 and then transmitted to the processing unit 21 of the management and control equipment 2 for identification, and the processing unit 21 of the management and control equipment 2 can then give an operation instruction (such as: read, erase, burn or check) synchronously to every electronic equipment host 1 to quickly perform the related operation.

Further, as described, the signal acquisition unit 23 is connected to the processing unit 21 of the management and control equipment 2 for acquiring external signal data from an external USB interface (for example, mobile hard disk drive with a USB interface). The signal hub 24 (USB Hub) is connected to the signal acquisition unit 23. Thus, through the signal control device 22, the processing unit 21 can control the signal acquisition unit 23 to access to the one or multiple mobile hard disk drives and/or flash drives that are connected to the signal hub 24. The signal control device 22 of the management and control equipment 2 can be a KVM (Keyboard-Video-Mouse) switch. Through the signal hub 24, the signal hub 24 is electrically coupled with peripheral devices, such as the keyboard 241, a video 242, the mouse 243 or a security device 244, and etc. Thus, through the signal control device 22, the keyboard 241, the video 242, the mouse 243, the security device 244 or other connected peripheral device can be used to operate the management and control equipment 2 in controlling multiple electronic equipment hosts 1.

It is to be noted that the embodiment described above is simply an example of the present invention but not intended to limit the scope of the present invention. The electronic signal transmission and control system enables the multiple electronic equipment hosts 1 to be electrically connected to the signal control device 22 of the management and control equipment 2 through the respective interface control units 11 and the address converter units 12, so that the address signal provided by each electronic equipment host 1 can be transmitted through the respective interface control unit 11 and calculated and analyzed by the respective address converter unit 12 and the signal control device 22 of the management and control equipment 2 for identification and reading by the processing unit 21, and the processing unit 21 responses the address signal to each electronic equipment host 1, and thus, the management and control equipment 2 can synchronously transmit the respective electronic signal addresses to the respective electronic equipment hosts 1 and synchronously control the operation of the multiple electronic equipment hosts 1. Further, the processing unit 21 of the management and control equipment 2 can analyze different address signals from different electronic equipment hosts 1 and can replay to the address signals according to the requirements of the respective electronic equipment host 1, facilitating quick operation of the electronic equipment hosts 1.

It conclusion, the invention provides an electronic signal transmission and control system, which comprises a plurality of electronic equipment hosts each comprising an interface control unit and an address converter unit connected to the interface control unit for converting the signal address transmitted by the associating electronic equipment host, and a management and control equipment, which comprises a signal control device for receiving the electronic signal addresses being transmitted at different times by the respective electronic equipment hosts and a processing unit connected to the signal control device for retrieving and reading the contents of the electronic signal address provided by each electronic equipment host and transmitting the processed electronic signal address through the signal control device to the respective electronic equipment host.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. An electronic signal transmission and control system, comprising:
a plurality of electronic equipment hosts, each said electronic equipment host comprising an interface control unit and an address converter unit electrically connected to said interface control unit for converting a signal address transmitted by the associating said electronic equipment host; and
a management and control equipment comprising a signal control device adapted for receiving the electronic signal addresses being transmitted at different times by the respective said electronic equipment hosts, a processing unit electrically connected to said signal control device and adapted for retrieving and reading the contents of the electronic signal address provided by each said electronic equipment host and transmitting the processed electronic signal address through said signal control device to the respective said electronic equipment host.

2. The electronic signal transmission and control system as claimed in claim 1, wherein said electronic equipment hosts are selected from the group of desktop computers, notebook computers, industrial computers and server computers.

3. The electronic signal transmission and control system as claimed in claim 1, wherein the said interface control units of said electronic equipment hosts are universal serial buses (USBs).

4. The electronic signal transmission and control system as claimed in claim 1, wherein the said address converter units of said electronic equipment hosts and said signal control device of said management and control equipment are configured to calculate the contents of the said electronic signal addresses through a matrix equation.

5. The electronic signal transmission and control system as claimed in claim 4, wherein said matrix equation is:
$$A = {X 1 , X 2 , X 3 , X 4 , X 5 , … , Xn}_{}^{} and B = ( \begin{matrix}Y 1 \\ Y 2 \\ Y 3 \\ Y 4 \\ Y 5 \\ ⋮ \\ Yn\end{matrix} ) , and$$
$$C = A \times B = ( X 1 \times Y 1 ) + ( X 2 \times Y 2 ) + ( X 3 \times Y 3 ) … ( XN \times YN ) .$$

6. The electronic signal transmission and control system as claimed in claim 5, wherein each coefficient of the equation A contains at least two electronic signal addresses transmitted by at least two electronic equipment hosts; each coefficient of the equation B is the address signal processed for response by a management and control equipment according to the electronic signal address of one respective said electronic equipment host.

7. The electronic signal transmission and control system as claimed in claim 1, wherein said processing unit of said management and control equipment is a microcontroller unit or chip; said management and control equipment further comprises a signal acquisition unit electrically connected to said processing unit for acquiring external signal data, and a signal hub (USB Hub) electrically connected to said signal acquisition unit.

8. The electronic signal transmission and control system as claimed in claim 1, wherein said signal control device of said management and control equipment is a KVM (Keyboard-Video-Mouse) switch.
